(19) United States
(12) Patent Application Publication
(10) Pub. No.: US 2002/0111151 A1
(43) Pub. Date: Aug. 15, 2002

(54) Block downconverter using a SBAR bandpass filter in a superheterodyne receiver

(76) Inventors: Reed A. Irion, Austin, TX (US); Hon Yee, Austin, TX (US); Prahalad K. Vasudev, Austin, TX (US); Sheela N. Vasudev, (US)

Correspondence Address: Jeffrey C. Hood, Conley, Rose, & Tayon, P.C., P.O. Box 398, Austin, TX, 78767, US

(21) Appl. No.: 09/785,081

(22) Filed: Feb. 15, 2001

(51) Int. Cl. H04B 1/26

(52) U.S. Cl. 455/325; 455/323; 455/313

(57) ABSTRACT

Several embodiments of a block downconverter using a SBAR bandpass filter in a superheterodyne receiver are disclosed. The block downconverter is coupled to receive a radio frequency input that includes a target region. The block downconverter is configured to produce a selected one of an overlapping plurality of portions of the target region as an intermediate frequency (IF) block having a fixed center frequency. Furthermore, the block downconverter includes a semiconductor bulk acoustic resonator (SBAR) filter that operates as an IF filter.

### FIELD OF THE INVENTION

This invention relates to signal analyzers, and more particularly to signal analyzers for radio frequency signals.

### DESCRIPTION OF THE RELATED ART

Heterodyne receivers are frequently used as radio frequency (RF) signal receivers. Heterodyne receivers convert a received RF signal to a fixed intermediate frequency (IF) by mixing, or heterodyning, the received signal with a local signal. By converting received signals to a fixed IF, a heterodyne receiver is able to use fixed-tuned amplifiers and filters, which generally have better selectivity and sensitivity than tunable amplifiers and filters.

In a superheterodyne receiver, the IF frequency is chosen to be higher than the desired output signal frequency. A simple superheterodyne receiver mixes an incoming RF signal with the output of a local oscillator to produce a fixed intermediate frequency signal. The local oscillator frequency can be adjusted as the input signal frequency changes so as to always produce an intermediate frequency at the same frequency. The mixer output actually consists of two components: an undesired component at a frequency equal to the sum of the input frequency and the oscillator frequency (called the image frequency) and the desired component at a frequency equal to the difference of the input frequency and the oscillator frequency. The image frequency differs from the desired frequency by twice the intermediate frequency and the undesired image frequency component is typically filtered out. In some receivers concerned with receiving higher frequencies, the signal may be mixed in several stages and thus being translated to several different fixed intermediated frequencies before finally being converted to the desired output signal frequency.

A heterodyne or superheterodyne receiver might be used in a block downconverter. A block downconverter may be configured to receive an RF input and to convert certain blocks or bands of the RF input signal to IF blocks that are centered around a different frequency but have the same bandwidth as the RF band. Block downconverters may be used in a variety of applications, including communication signal analyzers.

### SUMMARY OF THE INVENTION

Several embodiments of a block downconverter using a SBAR bandpass filter in a superheterodyne receiver are disclosed. In one embodiment, an apparatus that includes a block downconverter is disclosed. In some embodiments, the apparatus may be a communications signal analyzer. The block downconverter is coupled to receive a radio frequency input. The radio frequency input includes a target region. The block downconverter is configured to produce a selected one of an overlapping plurality of portions of the target region as an intermediate frequency (IF) block having a fixed center frequency. Furthermore, the block downconverter includes a semiconductor bulk acoustic resonator (SBAR) filter that operates as an IF filter in the block downconverter. The SBAR filter may include one or more piezoelectric resonators. In some embodiments, the SBAR filter may include a layer of piezoelectric material, a pair of electrodes mounted on one surface of the piezoelectric material, and a third electrode mounted on an opposing surface of the piezoelectric material so that each electrode of the pair is mounted in overlapping relation to the third electrode to create two series connected resonators that are the only connections to the third electrode. In some embodiments, the two series connected resonators may have identical resonant frequencies. In one embodiment, the SBAR filter may include a piezoelectric resonator-based T network. In another embodiment, the SBAR filter may include a piezoelectric resonator-based pi network. The SBAR filter may include a piezoelectric resonator-based L network in one embodiment.

In one embodiment, the block downconverter may include a first IF section that is configured to produce a first IF signal having a center frequency of 3.2 GHz. This first IF section may include a SBAR filter that has a center frequency of 3.2 GHz and is configured to filter the first IF signal.

In another embodiment, a block downconverter is disclosed. The block downconverted includes a radio frequency section coupled to receive a radio frequency input and configured to produce a target region of the radio frequency input. The block downconverter also includes a local oscillator configured to produce a local oscillator signal having a frequency greater than a highest frequency of the target region of the radio frequency input. The block downconverter includes an intermediate frequency (IF) section coupled to receive the target region and the local oscillator signal and configured to heterodyne electromagnetic waves in the target region within the local oscillator signal to produce an IF frequency band, and wherein a lowest frequency of the IF frequency band is greater than the highest frequency of the target region of the radio frequency input. The IF section includes one or more semiconductor bulk acoustic resonator (SBAR) bandpass filters that include at least one SBAR, and at least one SBAR bandpass filter has a center frequency which is the same as a center frequency of the IF frequency band. The target region of the radio frequency input may extend from about 9 kHz to approximately 2.6 GHz. The local oscillator signal may vary from about 3.2 GHz to approximately 5.8 GHz and may be variable in increments of about 1 MHz. The IF frequency band may have a center frequency of about 3.2 GHz.

In another embodiment, a method of heterodyning a RF signal having a frequency from about 9 kHz to approximately 2.6 GHz is disclosed. The RF signal is received. A 20 MHz band of the received RF signal is mixed with a signal from a local oscillator to produce a first IF band having a center frequency of 3.2 GHz. The first IF band is passed through an SBAR bandpass filter having a center frequency of 3.2 GHz. In some embodiments, the SBAR filter may include a piezoelectric resonator-based T network. In other embodiments, the SBAR filter may include a piezoelectric resonator-based pi network. In one embodiment, the SBAR filter may include a piezoelectric resonator-based L network.

### BRIEF DESCRIPTION OF THE DRAWINGS

A better understanding of the present invention can be obtained when the following detailed description of the preferred embodiment is considered in conjunction with the following drawings, in which:

FIG. 1 illustrates one embodiment of a communications signal analyzer;

FIG. 2 illustrates one embodiment of the operation of a block downconverter;

FIG. 3 shows one embodiment of a block downconverter;

FIG. 4 shows one embodiment of an RF section;

FIG. 5 illustrates one embodiment of a first IF section;

FIG. 6a shows one example of a piezoelectric resonator-based T network;

FIG. 6b shows one example of a piezoelectric resonator-based pi network;

FIG. 6d shows one example of a piezoelectric resonator-based L network;

FIG. 7 shows one embodiment of a first local oscillator;

FIG. 8 illustrates one embodiment of a second IF section;

FIG. 9 shows another embodiment of second local oscillator; and

FIG. 10 shows one embodiment of a third IF section.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENT

Incorporation by Reference

The following are hereby incorporated by reference as though fully and completely set forth herein:

U.S. Pat. No. 5,231,327 titled “Optimized Piezoelectric Resonator-Based Networks, issued to Ketcham; and

U.S. Pat. No. 5,404,628 titled “Method for Optimizing Piezoelectric Resonator-Based Networks,” issued to Ketcham.

Description of Figures

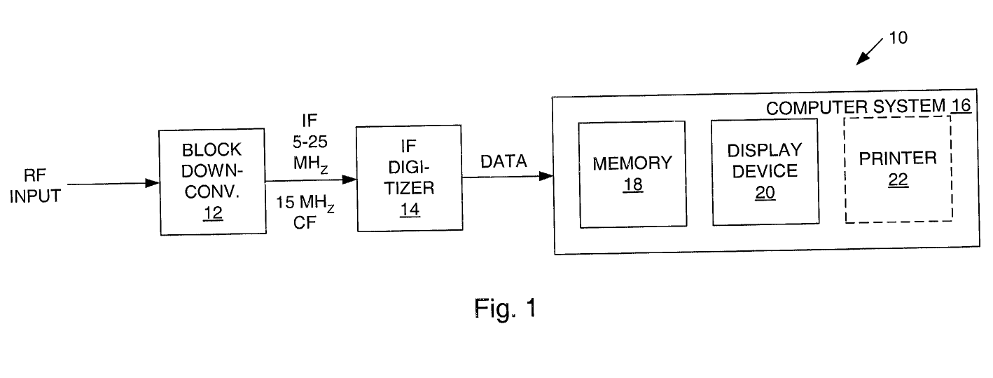

FIG. 1 is a diagram of one embodiment of a communications signal analyzer (CSA) 10. CSA 10 includes a block downconverter 12, an intermediate frequency (IF) digitizer 14, and a computer system 16. Block downconverter 12 receives a radio frequency (RF) input. The RF input includes electromagnetic waves, and may include a portion ranging from 9 kHz to 2.6 GHz. One or more RF signals may exist in the portion of the RF input ranging from 9 kHz to 2.6 GHz.

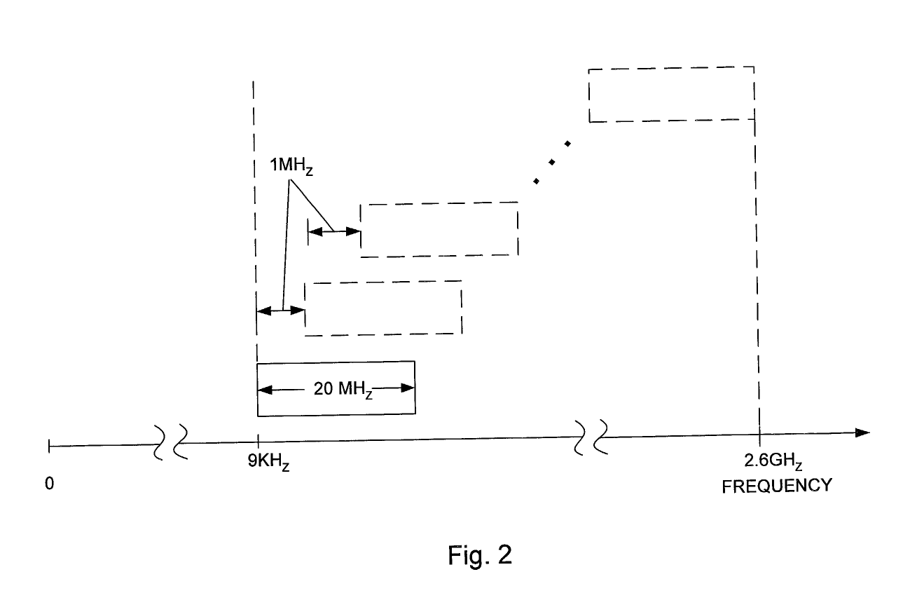

FIG. 2 is a diagram illustrating the operation of block downconverter 12. Block downconverter 12 works as a superheterodyne receiver by converting a received RF signal to a fixed intermediate frequency. Block downconverter 12 converts electromagnetic waves within a selected 20 MHz band or “block” of the portion of the RF input ranging from 9 kHz to 2.6 GHz to an IF frequency band or “block” having a frequency range extending from 5 to 25 MHz, and having a center frequency of 15 MHz. As illustrated in FIG. 2, the 20 MHZ blocks produced by block downconverter 12 are separated by 1 MHz “steps,” and adjacent 20 MHz blocks have a 19 MHz overlap. Block downconverter 12 produces a selected one of an overlapping set of 20 MHz blocks of the portion of the RF input ranging from 9 kHz to 2.6 GHz as a 20 MHz IF frequency block having a fixed center frequency of 15 MHz.

Referring back to FIG. 1, IF digitizer 14 receives the 20 MHz IF frequency block produced by block downconverter 12. IF digitizer 14 includes an analog-to-digital converter (ADC) which quantizes and samples the electromagnetic waves present in the IF frequency block, producing digital data indicative of the voltage levels of the electromagnetic waves present in the IF frequency block. IF digitizer 14 may also include circuitry to perform signal processing and/or analysis operations upon the digital data (e.g., filtering, amplification, attenuation, level shifting, Fourier transformation, etc.). IF digitizer 14 provides digital data to computer system 16 derived from the electromagnetic waves present in the IF frequency block.

Computer system 16 includes a memory 18, a display device 20, and an optional printer 22. Computer system 16 receives the digital data produced by IF digitizer 14, and stores the digital data in memory 18. Computer system 16 may include circuitry to perform signal processing and/or analysis operations upon the data (e.g., filtering, amplification, attenuation, level shifting, Fourier transformation, etc.). In response to user input, computer system 16 may display digital data derived from the electromagnetic waves present in the IF frequency block upon display device 20. The user may also use optional printer 22 to obtain a hard copy of the digital data derived from the electromagnetic waves present in the IF frequency block.

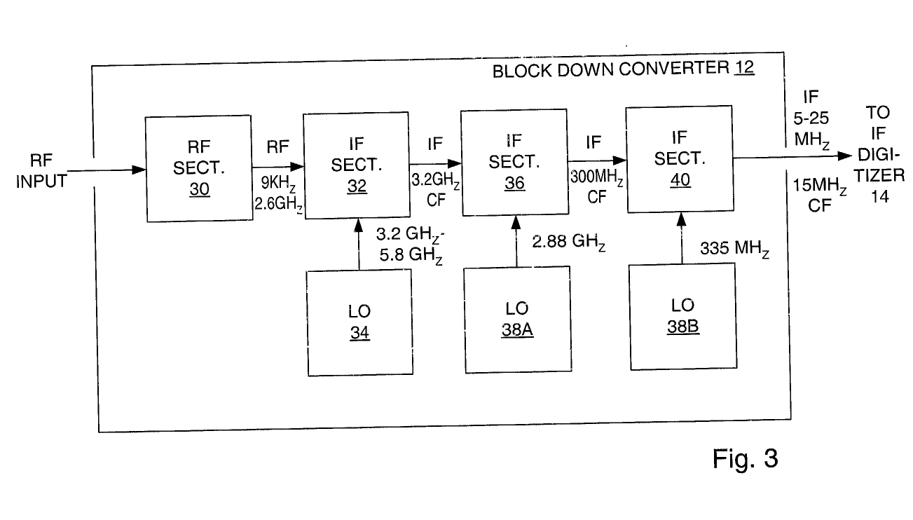

FIG. 3 is a diagram of one embodiment of block downconverter 12 of FIG. 1. In the embodiment of FIG. 3, block downconverter 12 includes an RF section 30, a first IF section 32, a first local oscillator (LO) 34, a second IF section 36, a second LO 38A, a third IF section 40, and a third LO 38B. RF section 30 receives the RF input and produces the portion of the RF input ranging from 9 kHz to 2.6 GHz. IF section 32 receives the portion of the RF input ranging from 9 kHz to 2.6 GHz from RF section 30 and a signal from LO 34, and produces a first IF band having a center frequency of 3.2 GHz. IF section 36 receives the first IF frequency from IF section 32 and a signal from LO 38A, and produces a second IF band having a center frequency of 320 MHz. IF section 40 receives the second IF frequency from IF section 36 and a signal from LO 38B, and produces a third IF band. The third IF band is centered at 15 MHz and extends from 5 to 25 MHz. The third IF band is the 20 MHz IF frequency block produced by block downconverter 12, and is the selected 20 MHz block of the portion of the RF input ranging from 9 kHz to 2.6 GHz.

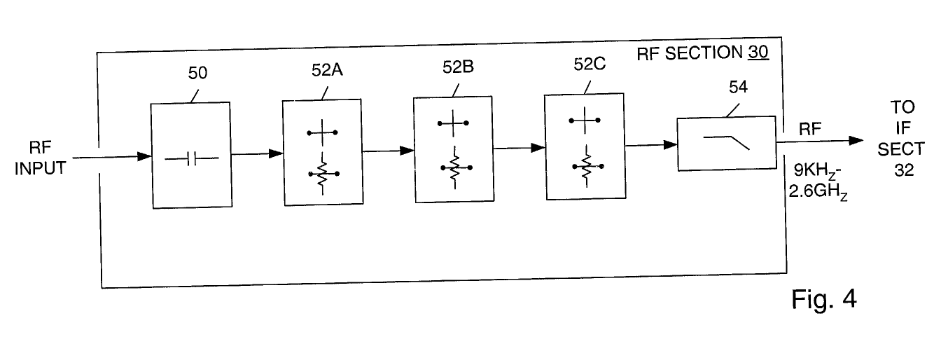

FIG. 4 is a diagram of one embodiment of RF section 30 of FIG. 3. In the embodiment of FIG. 4, RF section 30 includes an alternating current (AC) coupling network 50, three switchable attenuators 52A-52C, and a low pass filter (LPF) 54, all connected in series as shown in FIG. 4. AC coupling network 50 receives the RF input and blocks any direct current (DC) in the RF input. Switchable attenuators 52A and 52B receive separate control signals, and each provides either 0 decibels (dB) or 20 dB of attenuation dependent upon the respective control signal. Switchable attenuator 52C receives a control signal and provides either 0 dB or 10 dB of attenuation dependent upon the control signal. LPF 54 is a filter having a−3 dB corner frequency of 2.6 GHz. LPF 54 produces the portion of the RF input ranging from 9 kHz to 2.6 GHz.

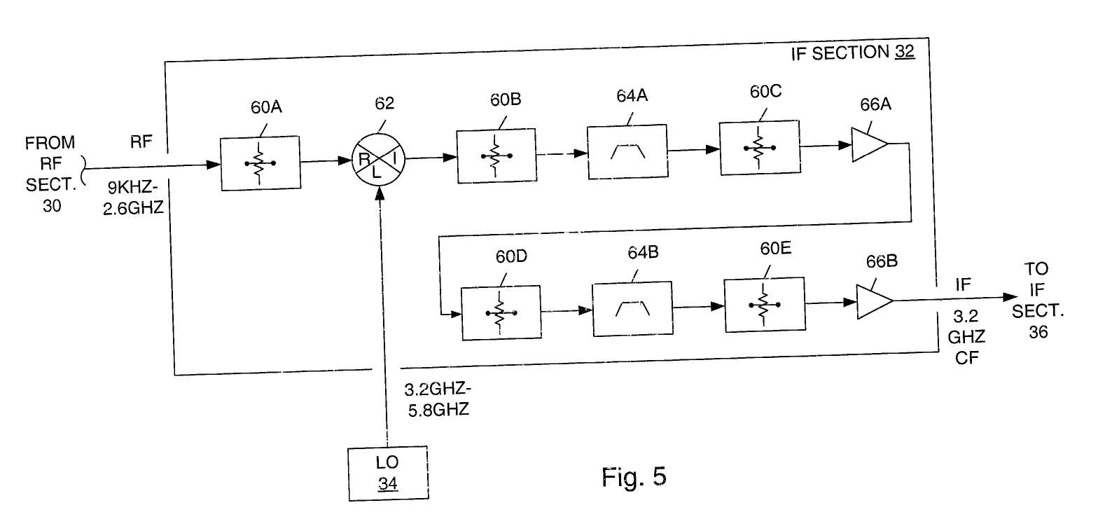

FIG. 5 is a diagram of one embodiment of IF section 32 of FIG. 3. In the embodiment of FIG. 5, IF section 32 includes five impedance matching networks 60A-60E, a mixer 62, two bandpass filters (BPFs) 64A-64B, and two amplifiers 66A-66B, all connected in series as shown in FIG. 5. Impedance matching networks 60A-60E provide needed impedance matching within IF section 32. Mixer 62 is coupled to receive the portion of the RF input ranging from 9 kHz to 2.6 GHz from RF section 30 and a signal from LO 34. The signal from LO 34 is variable from 3.2 GHz to 5.8 GHz in increments of about 1 MHz, and the frequency of the signal from LO 34 is selected such that block downconverter 12 produces a desired 20 MHz block of the portion of the RF input ranging from 9 kHz to 2.6 GHz. Mixer 62 heterodynes or mixes the portion of the RF input ranging from 9 kHz to 2.6 GHz with the signal from LO 34, producing an RF spectrum including a first IF band centered at 3.2 GHz. Having a high first IF improves image rejection.

BPFs 64A-64B are coupled in series between an output of mixer 62 and an output of IF section 32. BPFs 64A-64B have center frequencies of about 3.2 GHz and−3 dB bandwidths. BPFs 64A-64B pass the first IF band centered at 3.2 GHz and sufficiently attenuate components of the RF spectrum produced by mixer 62 outside of the bandwidths of BPFs 64A-64B. IF amplifier 66A is coupled between BPF 64A and BPF 64B, and amplifies the first IF band after the first IF band passes through BPF 64A and before the first IF band passes through BPF 64B. IF amplifier 66B is coupled between an output of BPF 64B and the output of IF section 32, and amplifies the first IF band after having passed through BPF 64B.

BPFs 64A-64B preferably include multiple semiconductor bulk acoustic resonators (SBARs) connected to form an SBAR bandpass filter. SBAR bandpass filters are advantageously smaller than other known types of filters. Suitable SBAR bandpass filters may be obtained from TFR Technologies, Inc., Bend, Oreg. Applicants note that the SBAR bandpass filters from TFR Technologies are advantageously free of resonances over a fundamental. In some embodiments, the SBAR bandpass filters may be similar to those disclosed by U.S. Pat. No. 5,231,327, titled “Optimized Piezoelectric Resonator-Based Networks,” issued to Ketcham or those disclosed in U.S. Pat. No. 5,382,930, titled “Monolithic Multipole Filters Made of Thin Film Stacked Crystal Filters,” issued to Stokes, et al. For example, the SBAR bandpass filters may be include a layer of piezoelectric material, a pair of electrodes mounted on one surface of the piezoelectric material, and a third electrode mounted on an opposing surface of the piezoelectric material so that each electrode of the pair is mounted in overlapping relation to the third electrode to create two series connected resonators that are the only connections to the third electrode. In other embodiments, other suitable SBAR bandpass filters may be used.

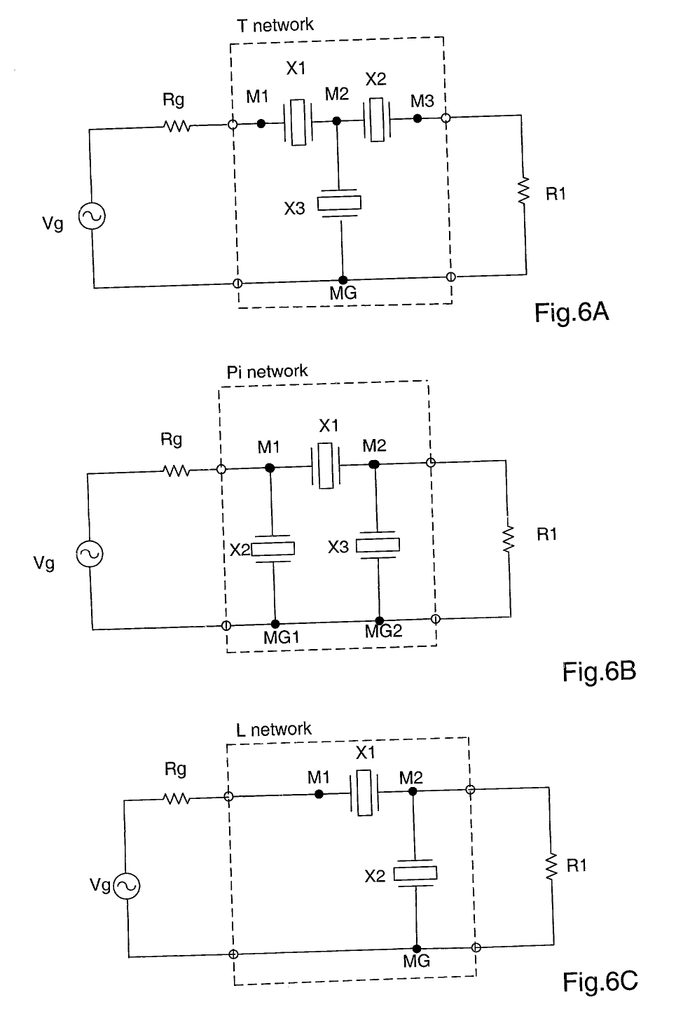

In one embodiment, the SBAR filter may include a piezoelectric resonator-based T network. FIG. 6a shows an example of an electrical circuit that includes a piezoelectric resonator-based T network. The T network includes resonator X1, series resonator X2 and shunt element resonator X3. In other embodiments, the SBAR filter may include a piezoelectric resonator-based pi network, such as the one exemplified in FIG. 6b. In FIG. 6b, the pi network includes several series connected resonators X1, X2, and X3. In still other embodiments, the SBAR filter may include a piezoelectric resonator-based L network. FIG. 6c shows an example of a piezoelectric resonator-based L network, which includes a series resonator X1 and a shunt element resonator X2.

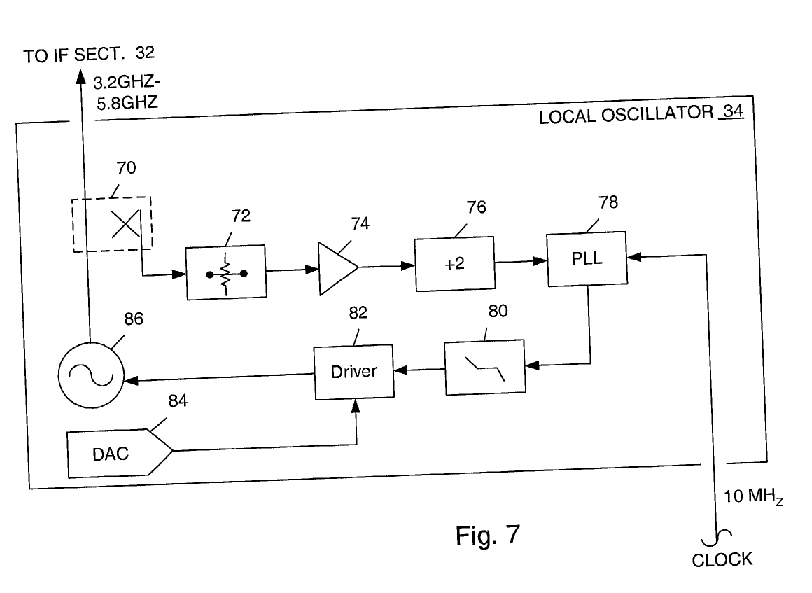

FIG. 7 is a diagram of one embodiment of local oscillator (LO) 34 of FIGS. 3 and 5. In the embodiment of FIG. 7, LO 34 includes a microstrip coupler 70, an impedance matching network 72, an amplifier 74, a prescaler 76, a phase-locked loop (PLL) 78, a loop filter 80, a driver 82, a digital-to-analog converter (DAC) 84, and an oscillator 86. As described above, LO 34 provides a signal to mixer 62 of IF section 32 which is variable from 3.2 GHz to 5.8 GHz in increments of about 1 MHz. The frequency of the output signal of LO 34 is selected such that block downconverter 12 produces a desired 20 MHz block of the portion of the RF input ranging from 9 kHz to 2.6 GHz.

Oscillator 86 produces the output signal of LO 34 dependent upon a control signal produced by driver 82. Microstrip coupler 70 is coupled to receive the signal produced by LO 34, and provides the signal to amplifier 74 via impedance matching network 72. Amplifier 74 amplifies the signal, and provides the signal to prescaler 76. Prescaler 76 divides the frequency of the signal by a factor of 2, and provides the resulting prescaled signal to PLL 78. PLL 78 also receives a 10 MHz clock signal. PLL 78 produces an output signal dependent upon a phase difference between the prescaled signal and the 10 MHz clock signal. Loop filter 80 receives the output signal produced by PLL 78 and filters the output signal. Driver 82 receives the filter output of PLL 78 and an output of DAC 84. The output of DAC 84 is dependent upon a digital input value. The digital input value is selected by the user in order to select the frequency of the output signal produced by LO 34. The digital value thus selects the desired 20 MHz block of the portion of the RF input ranging from 9 kHz to 2.6 GHz produced by block downconverter 12. Driver 82 produces the control signal dependent upon the filtered output of PLL 78 and the output of DAC 84.

Oscillator 86 is preferably a current-controlled yttrium iron garnet (YIG) oscillator, and the control signal produced by driver 82 is preferably a current signal.

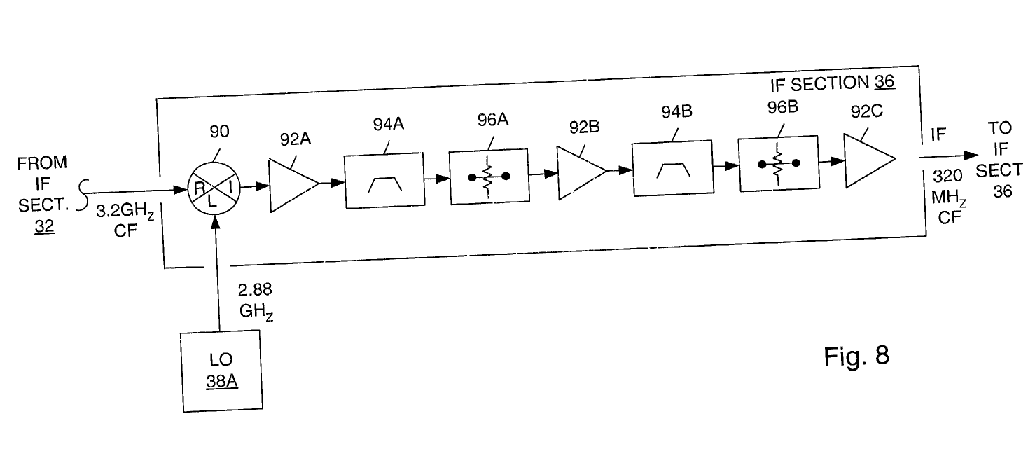

FIG. 8 is a diagram of one embodiment of second IF section 36 of FIG. 3. In the embodiment of FIG. 8, IF section 36 includes a mixer 90, three amplifiers 92A-92C, two bandpass filters (BPFs) 94A-94B, and two impedance matching networks 96A-96B, all connected in series as shown in FIG. 8. Mixer 90 is coupled to receive the first IF band centered at 3.2 GHz from first IF section 32 and a signal from LO 38A. The signal from LO 38A is fixed at 2.88 GHz such that second IF section 36 produces a desired second IF band centered at 320 MHz. Mixer 90 heterodynes or mixes the first IF band centered at 3.2 GHz with the signal from LO 38A, producing an RF spectrum including the desired second IF band centered at 320 MHz. IF amplifier 92A is coupled between an output of mixer 90 and an input of BPF 94A, and amplifies the second IF band centered at 320 MHz before the second IF band is passed through BPF 94A.

BPFs 94A-94B are coupled in series between the output of mixer 90 and an output of IF section 36. BPFs 94A-94B have center frequencies of about 320 MHz and −3 dB bandwidths of about 22 MHz. BPFs 94A-94B pass the second IF band centered at 320 MHz and sufficiently attenuate all components of the RF spectrum produced by mixer 90 outside of the 22 MHz bandwidth of BPFs 94A-94B. Impedance matching networks 96A-96B provide needed impedance matching within IF section 36. IF amplifier 92B is coupled between BPF 94A and BPF 94B, and amplifies the second IF band centered at 320 MHz after the second IF band is passed through BPF 94A and before the second IF band is passed through BPF 94B. IF amplifier 92C is coupled between an output of BPF 94B and the output of IF section 36, and amplifies the second IF band centered at 320 MHz after having passed through BPF 94B.

BPFs 94A-94B are preferably include multiple surface acoustic wave (SAW) resonators connected to from a SAW bandpass filter. Suitable SAW bandpass filters are available from Sawtek Incorporated in Orlando, Fla.

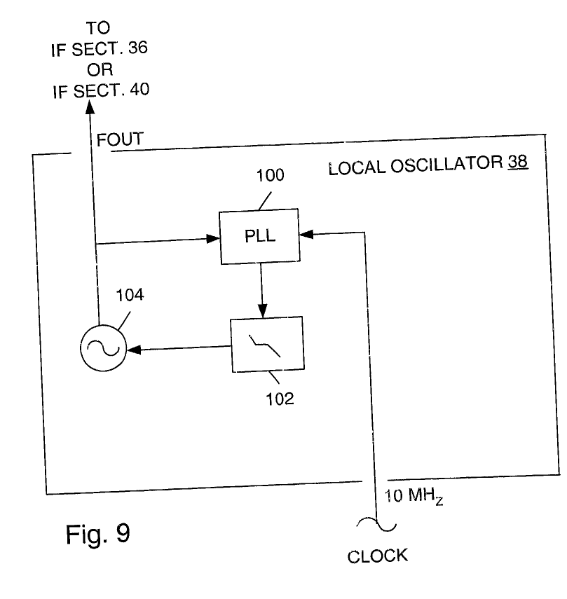

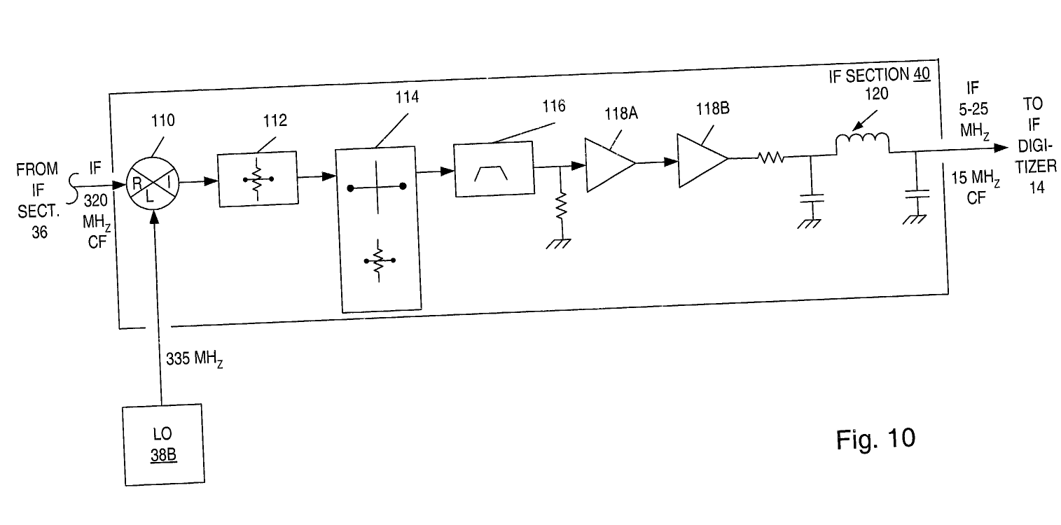

FIG. 9 is a diagram of one embodiment of local oscillator (LO) 38 representative of LO 38A of FIGS. 3 and 8 and LO 38B of FIGS. 3 and 10. In the embodiment of FIG. 9, LO 38 includes a phase-locked loop (PLL) 100, a loop filter 102, and an oscillator 104. As described above, LO 38A provides a signal to mixer 90 of second IF section 36 which is fixed at 2.88 GHz such that second IF section 36 produces the desired second IF band centered at 320 MHz. As will be described below, LO 38B provides a signal to a mixer of third IF section 40 which is fixed at 335 MHz such that third IF section 40 produces a desired third IF band centered at 15 MHz.

Oscillator 104 produces an output signal FOUT of LO 38 dependent upon a control signal produced by loop filter 102. Oscillator 104 is preferably a voltage-controlled oscillator, and the control signal produced by loop filter 102 is preferably a voltage signal. PLL 100 receives the output signal and the 10 MHz clock signal. PLL 100 produces an output signal dependent upon a phase difference between the output signal and the 10 MHz clock signal. Loop filter 102 receives the output signal produced by PLL 100 and filters the output signal to produce the control signal.

FIG. 10 is a diagram of one embodiment of third IF section 40 of FIG. 3. In the embodiment of FIG. 10, IF section 40 includes a mixer 110, a first impedance matching network 112, a switchable attenuator 114, a bandpass filter (BPF) 116, two amplifiers 118A-118B, and a second impedance matching network 120, all connected in series as shown in FIG. 10. Mixer 110 is coupled to receive the second IF band centered at 320 MHz from second IF section 36 and a signal from LO 38B. The signal from LO 38B is fixed at 335 MHz such that third IF section 40 produces a desired third IF band centered at 15 MHz.

Mixer 110 heterodynes or mixes the second IF band centered at 320 MHz with the signal from LO 38B, producing an RF spectrum including the desired third IF band centered at 15 MHz. Impedance matching networks 112 and 120 provide needed impedance matching within IF section 40. Switchable attenuator 114 receives a control signal and provides either 0 dB or 10 dB of attenuation dependent upon the control signal. BPF 116 is coupled in series between an output of mixer 110 and an output of IF section 40. BPF 116 has a center frequency of about 15 MHz and −3 dB corner frequencies of approximately 1 MHz and 50 MHz. BPF 116 passes the third IF band centered at 15 MHz and sufficiently attenuates all components of the RF spectrum produced by mixer 110 above and below the −3 dB corner frequencies of BPF 116. IF amplifiers 118A-118B are coupled between an output of BPF 116 and an output of IF section 40, and amplify the third IF band centered at 15 MHz after having passed through BPF 116.

Block downconverter 12 produces the third IF band produced by IF section 40. The third IF band has a −3 dB bandwidth of about 20 MHz. As described above, the third IF band is the 20 MHz IF frequency block produced by block downconverter 12, and is the desired 20 MHz block of the portion of the RF input ranging from 9 kHz to 2.6 GHz.

Numerous variations and modifications will become apparent to those skilled in the art once the above disclosure is fully appreciated. It is intended that the following claims be interpreted to embrace all such variations and modifications.

What is claimed is:

1. An apparatus, comprising:
a block downconverter coupled to receive a radio frequency input including a target region and configured to produce a selected one of an overlapping plurality of portions of the target region as an intermediate frequency (IF) block having a fixed center frequency;
wherein the block downconverter includes a semiconductor bulk acoustic resonator (SBAR) filter, wherein the SBAR filter operates as an IF filter in the block downconverter.

2. The apparatus of claim 1, wherein the SBAR filter comprises a piezoelectric resonator.

3. The apparatus of claim 1, wherein the SBAR filter comprises:
a layer of piezoelectric material;
a pair of electrodes mounted on one surface of the piezoelectric material; and
a third electrode mounted on an opposing surface of the piezoelectric material;
each electrode of the pair mounted in overlapping relation to the third electrode to create two series connected resonators that are the only connections to the third electrode.

4. The apparatus of claim 3, wherein the two series connected resonators have identical resonant frequency.

5. The apparatus as recited in claim 1, wherein the SBAR filter comprises a piezoelectric resonator-based T network.

6. The apparatus as recited in claim 1, wherein the SBAR filter comprises a piezoelectric resonator-based pi network.

7. The apparatus as recited in claim 1, wherein the SBAR filter comprises a piezoelectric resonator-based L network.

8. The apparatus as recited in claim 1, wherein the apparatus is a communications signal analyzer.

9. The apparatus as recited in claim 1, wherein the block downconverter comprises a first IF section configured to produce a first IF signal having a center frequency of 3.2 GHz, wherein the first IF section further comprises the SBAR filter, and wherein the SBAR filter has a center frequency of 3.2 GHz and is configured to filter the first IF signal.

10. A block downconverter, comprising:
a radio frequency section coupled to receive a radio frequency input and configured to produce a target region of the radio frequency input;
a local oscillator configured to produce a local oscillator signal having a frequency greater than a highest frequency of the target region of the radio frequency input;
an intermediate frequency (IF) section coupled to receive the target region and the local oscillator signal, wherein the IF section is configured to heterodyne electromagnetic waves in the target region within the local oscillator signal to produce an IF frequency band, and wherein a lowest frequency of the IF frequency band is greater than the highest frequency of the target region of the radio frequency input.
wherein the IF section comprises one or more semiconductor bulk acoustic resonator (SBAR) bandpass filter comprising at least one SBAR, and wherein one of the SBAR bandpass filters has a center frequency which is the same as a center frequency of the IF frequency band;
wherein the target region of the radio frequency input extends from about 9 kHz to approximately 2.6 GHz;
wherein the local oscillator signal varies from about 3.2 GHz to approximately 5.8 GHz;
wherein the local oscillator signal is variable in increments of about 1 MHz; and
wherein the IF frequency band has a center frequency of about 3.2 GHz.

11. A method of block downconverting an RF signal having a frequency from about 9 kHz to approximately 2.6 GHz, comprising:
receiving the RF signal;
mixing a 20 MHz band of the received RF signal with a signal from a local oscillator to produce a first IF band having a center frequency of 3.2 GHz;
passing the first IF band through an SBAR bandpass filter having a center frequency of 3.2 GHz; and
producing a target region of the received RF signal.

12. The method as recited in claim 11, wherein the SBAR filter comprises a piezoelectric resonator-based T network.

13. The method as recited in claim 11, wherein the SBAR filter comprises a piezoelectric resonator-based pi network.

14. The method as recited in claim 11, wherein the SBAR filter comprises a piezoelectric resonator-based L network.
